(19) United States
(12) Patent Application Publication
(10) Pub. No.: US 2012/0164607 A1
(43) Pub. Date: Jun. 28, 2012

(54) Application system of multidimensional chinese learning

(76) Inventor: Wanbo Qu, Daqing City (CN)

(21) Appl. No.: 11/629,026

(22) PCT Filed: Apr. 29, 2005
(86) PCT No.: PCT/CN2005/000597

§ 371 Date: Nov. 20, 2008

(30) Foreign Application Priority Data
Jun. 10, 2004 (CN) 200410043625.2
Jun. 14, 2004 (CN) 200410048072.X
Sep. 18, 2004 (CN) 200410080000.3
Dec. 18, 2004 (CN) 200410100853.9

(51) Int. Cl. G09B 19/06

(52) U.S. Cl. 434/157

(57) ABSTRACT

A multidimensional Chinese learning application system includes a main computer, a data storage device installed in the mainframe computer, and an input device, characterized by said data storage device comprises: a PinYin module including an initial study unit, a single-final study unit, a multiple-final study unit, an overall reading unit and an exercise unit; a character recognizing module including a stroke unit, a stroke order unit, a structure unit, a component unit, an encoding unit and a game unit; a dictionary searching module, including an input unit, an inquiry unit and a display unit.

### FIELD OF THE INVENTION

The present invention relates to language learning, in particular, to a multidimensional Chinese learning system and method.

### BACKGROUND ART

With the development of computer technology, there come various computer-assisted learning systems and approaches, most of which attract learners by multimedia experiences with characteristics as large storage capacity and high interaction. For example, the granted patent with Publication No. CN1366259A is a good example that discloses a learning system and approach. However, it only applies advanced multimedia technology into learning activities, but fails to carry out direct man-machine dialogue, man-machine combination, or combination of teaching and learning, which is extremely important for language learning. The granted patent with Publication No. CN1474264A, as another exemplary patent for language learning by means of computer dialogue, is an interactive learning method, which selects role information by computer and compares the learner's recording. However, the method is rather flat in its content and form, so it is impossible for the learners to make a profound understanding of the inherent meaning of language and characters. Therefore, the study effect and progress are still not satisfying, especially not suitable for compatible requirements for children and adults, Chinese and foreigners at the same time.

### DESCRIPTION OF THE INVENTION

The present invention is designed for solving the shortage of current available techniques, using big component encoding, which selects among frequently used single character, overlapped character and incorporated character that are not suitable to division (all of which are often used as radicals), located at the 26 English alphabetical key according to pronunciations, shapes and meanings, and thus develops a multidimensional Chinese learning system.

The so-called multidimensional encoding uses multidimensional component encoding as essential technology, according to the multidimensional information of Chinese characters' pronunciations, shapes and meanings, said characters are properly divided into a set of ordered components on the basis of a set of rules, then are input into a computer based on encoding rules and are converted into Chinese characters (words). Said integrated, united and synchronous learning rule comprises, characters recognizing (recognizing characters), ortho—(orthoepy and orthography), querying (querying electronic dictionaries, word dictionaries and idioms dictionaries) and typing (typing characters), which is achieved by means of learning PinYin, learning components and querying dictionaries simultaneously. On the other hand, the input method considers the frequently used components of single character, radicals, five strokes, and other basic components (which do not belong to the above three categories) as four encoding elements, then designs the keyboard layout according to the pronunciations, shapes and meanings of Chinese characters, encodes Chinese characters according to a standardized method of dividing Chinese characters, and thus completes the inputting of characters and words.

The technical solution of the present invention is to provide a Chinese language learning approach, which is based on a novel Chinese inputting method.

Said technical solution of the Chinese inputting method is described as below:

According to the [symbol] Component Criterion [symbol] for Chinese characters, those components frequently used for constructing characters are designed at 26 alphabetic keys on the standard computer keyboard, which could be permuted and combined according to the correspondence between PinYin initials, finals or shapes of the components and 26 English letters, thus constitutes 26 encoding keys of Chinese characters located at 26 alphabetic keys on the standard computer keyboard. The specific details are as follows:

(1) Dividing Chinese characters into the “five basic strokes”, “basic component character”, “basic component”, “ordinary component character” and “ordinary component”, which are elements for constructing Chinese characters, a character may be divided into one or more elements, collectively referred to as component;

The five basic strokes, including “ [symbol] ”, “ [symbol] ”, “ [symbol] ”, “ [symbol] ”, “ [symbol] ”, are placed at the alphabetic keys “H”, “S”, “D”, “P” and “Z” on the standard computer keyboard, according to the pronunciations of their names;

Basic component character: 26 characters, including single characters, overlapped characters, un-dividable integrated characters, which are mostly used as radicals, are located at the 26 alphabetic keys according to their initial or final pronunciations or pictographs;

Basic component: The deformation components of the basic component characters are located at the same keys as the basic component characters;

Ordinary component character: 245 characters, including single characters, overlapped characters, un-dividable integrated characters, which are mostly used as radicals, are distributed at the 26 alphabetic keys according to their initial or final pronunciations or pictographs; wherein the pronunciations “yi”, “yu”, “ya”, “wo”, “shou” are placed at 5 alphabetic keys on computer keyboard corresponding to their respective first letter of the PinYin of the final;

Ordinary component: components that are derived from deformation of ordinary component characters either with same pronunciations and similar shapes or frequently used as radicals, are located at the same places as the ordinary component characters, the resultant keyboard is combined with the existing computer;

(2) The Chinese character inputting method: to divide Chinese characters into components, encode the components according to the stroke order of Chinese characters, and input Chinese characters by striking corresponding keys on the keyboard, so as to input a Chinese character.

Based on said input method, each key on the keyboard corresponds to a basic component character and a plurality of components.

The present invention is designed follow relevant national standards and norms of Chinese characters, wherein single characters and overlapped characters are no more divided into components, but only divided into strokes based on stroke order. To meet the requirements of Chinese learning and inputting, the present invention adopts the rules of entire character encoding, entire character inputting, entire character reading and no dividing for single characters and overlapped characters, designing the 26 alphabetic keys of the keyboard with consideration of the pronunciations firstly and the shapes secondly. The dividing principles include the following:

1. A character is divided based on stroke order;

2. A detachable or conjoint character can be divided;

3. A component character cannot be divided;

4. An overlapped character cannot be divided, but the overlapped portion can be divided into strokes according to stroke order, wherein a few stroke bonds which do not affect the structure and stroke number are considered as conjoint.

For example:

“ [symbol] ” is divided into “ [symbol] ” and “ [symbol] ” (detachable).

“ [symbol] ” is divided into “ [symbol] ” and “ [symbol] ” (conjoint).

“ [symbol] ” is divided into “ [symbol] ” and “ [symbol] ”, “ [symbol] ” has the most number of strokes.)
but cannot be divided into“ [symbol] ” and “ [symbol] ”.

“ [symbol] ” is divided into “ [symbol] ” and “ [symbol] ”, (According to stroke order, “ [symbol] ” is written firstly.)
but cannot be divided into“ [symbol] ” and “ [symbol] ”.

“ [symbol] ” cannot be divided into “ [symbol] ” and “ [symbol] ” (overlapped),
and cannot be divided into “ [symbol] ”, “ [symbol] ” and “ [symbol] ”,
but can be divided into “ [symbol] ”, “ [symbol] ”, “ [symbol] ”, “ [symbol] ”, “ [symbol] ”, “ [symbol] ”, “ [symbol] ”.

“ [symbol] ” can be divided into “ [symbol] ” and “ [symbol] ” (considering the stroke bonds as conjointness).

According to the above rules, the multidimensional Chinese inputting method of the present invention includes the following:

(1) Character inputting, including:

A component character: firstly to input the alphabetic key where the component character locates, secondly, according to stroke order, to input the alphabetic keys where the first, second and last strokes locate;

Two component characters: to input the alphabetic keys where both components locate and the alphabetic keys where the first strokes of the components locate:

Three or four component characters: to input the alphabetic key where each component locates;

More than four component characters: to input the alphabetic keys where the first, second, third, and last component keys locate;

(2) Word inputting, including:

Two-character word: to input the alphabetic keys of the first two components of the two characters; if one of them is a component character, just input its alphabetic key; if both are component characters, after inputting alphabetic keys of both component characters, to input the alphabetic key of the second component again;

Three-character word: to input the alphabetic keys where the first components of the first two characters and the first two components of the third character locate; if there is a component character, only to input the alphabetic key of the component character;

Four-character word: to input the alphabetic key of the first components of each character; if there is a component character, only to input the alphabetic key of the component character;

Multi-character word: to input the alphabetic keys where the first components of the first four characters locate; if there is a component character, only to input the alphabetic key of the component character;

(3) Brevity code character inputting, including:

During the Chinese inputting process, the most frequently used Chinese characters can be completed without inputting the entire codes. Thus, there are 10 first-degree brevity codes set in each key, press the alphabetic key where the first letter of the pronunciation locates, then press SPACE; to input second-degree brevity code, press the alphabetic keys where two components of the character (which is consisted of said two components) locate, then press SPACE; to input with third-degree brevity code, press the alphabetic the keys where the first three components of the character locate, then press SPACE.

The Chinese inputting method encoded by the present invention is compatible with corresponding inputting methods such as simplified characters, traditional characters, English words and PinYins.

In order to input Chinese characters quickly and conveniently, the present invention divides single characters and overlapped characters into components or strokes according to the stroke order.

With the inputting method provided in the present invention, the technical solution of the multidimensional Chinese learning system is as follows: a system including a mainframe computer, a data storage device installed in the mainframe computer, and an input device, said data storage device comprises:

a PinYin module including a initial learning unit, a single-final learning unit, a multiple-final learning unit, an overall reading unit and an exercise unit;

a recognizing module including a stroke unit, a stroke order unit, a structure unit, a component unit, an encoding unit and a game unit;

a dictionary querying module including an input unit, a querying unit and a display unit.

As a further improvement of the present invention, the exercise unit of the PinYin module comprises at least one of PinYin exercises, pictures recognizing, comparison of initials and finals, phrase exercises and sentence exercises.

Each unit in the PinYin module and recognizing module comprises at least one of PinYin tips, stroke order, sounds, pictures, animations, background music and display unit.

The component unit comprises at least one of key encoding, character constructing, PinYins, radicals, character building, structures, multidimensional codes, dynamic and static stroke orders, division, encoding rules, pronunciations, evolution of Chinese characters, background music, word constructing, word properties and interpretations.

The querying unit comprises at least one of encoding inquiries, radical inquiries, PinYin inquiries and overall character inquiries.

The display unit of dictionary inquiry module comprises at least one of character sequence, word constructing, radicals, stroke orders and interpretations.

With the above devices, the multidimensional Chinese learning method of the invention uses a mainframe computer, an input unit and a data storage unit installed in the mainframe computer, characterized by the following procedures:

1. PinYin study is to learn the initials, finals, overall pronunciations, syllabic pronunciations, and four tones of Chinese characters, including initial study, single-final study, multiple-final study, overall pronunciations and PinYin exercises. PinYin study sets up buttons for initials, single-final, multiple final, overall pronunciations and PinYin exercises in computer user interface, each stage of the study comprising function buttons for PinYin and alphabetic writing, pronunciation tips, four tones and background music, more specifically including the pronunciation study of the 23 initials, 6 single-finals, 18 multiple finals, 16 overall syllables.

2. Recognizing study is to learn the five basic strokes, stroke orders and structures of Chinese characters, to learn components which can construct characters, and single characters and integrated characters constructed by said components, and then to practice component encoding. Recognizing study includes learning basic component characters and ordinary component characters. The first thing to learn is the basic component characters on 26 alphabetic keys of the generic computer keyboard. With the study of the PinYins, shapes and meanings of basic component characters, relative homophones and characters with the same radicals are mastered at the same time; ordinary component characters including 237 character components. Ordinary components comprise 5 basic strokes, 94 non-character components; define the encoding on 26 alphabetic keys according to pronunciations and shapes. While learning ordinary components, click the component button to learn classifications of the ordinary components. Strokes, stroke orders, division methods, encoding rules of Chinese characters and the multidimensional Chinese input method will be mastered during the process of learning components. The study of 26 basic component characters and 237 ordinary component characters offer corresponding graphical interfaces with PinYin, reading/writing functions, the formation of hieroglyphs and step-by-step evolution of Chinese characters.

After learning the 26 basic component characters and 237 ordinary component characters, characters are encoded in relation to their pronunciations, shapes and meanings, and considering the fact that most of Chinese characters have the same meanings as their radicals and spell like the others, the study is focused on characters with same shape components or same pronouncing components. In this way, a number of approximate 1,500 frequently used Chinese characters could be grasped.

3. Dictionary inquiry uses component encoding to query electronic dictionary, to learn pronunciations and meanings of Chinese characters, Chinese and English interpretation of words, and to query the entire character by inputting code in the typing unit. There are windows displaying querying manner, inputting manner and comprehensive study related to the inputting on the computer interface of dictionary inquiry. Electronic dictionary inquiry includes displaying function buttons and relative input for character inquiries, encoding inquiries, PinYin inquiries and radical inquiries, and windows for characters and words related to the inputting with their interpretations, static stroke orders, Chinese PinYins and character encodings.

Every learning step of the above includes a display unit.

In addition, each of the PinYin study and recognizing study comprises at least one of pronunciation tips, stroke orders, sounds, pictures, animations and background music.

The PinYin exercise unit of said PinYin learning procedure consists of:

PinYin exercise: an arbitrary combining exercise of initials and finals;

Picture based character Recognizing: Chinese character recognizing with reference to real graphical objects;

Initial and final hitting: clicking START button with a mouse, displaying audio and video of Chinese character, searching for the final adapted to the initial, and playing audio tips;

Phrase and sentence exercises: displaying Chinese characters with PinYins, English interpretation and pronunciation.

Character recognizing study is completed by at least one of key encoding, character constructing, PinYins, strokes, radicals, character building, structures, multidimensional codes, static and dynamic orders, division, encoding rules, pronunciations, evolution of Chinese characters, background music, word constructing, word properties and meanings.

The present invention provides a multidimensional Chinese learning system, which uses modern technology of computer and multimedia, integrates multidimensional component encoding technology, Chinese inputting, electronic dictionaries, word dictionaries, idiom dictionaries, character libraries and professional character libraries, runs two kinds of characters (traditional and simplified) by one encoding scheme, step-by-step learning, distributed encoding and usages, all of which are united, easy to learn, remember and use, and follows the intrinsic rules of Chinese learning. With Chinese PinYin study, Chinese character component study and the concentrated/distributed learning method of recognizing, a new Chinese learning system is thereby established with integrated, united and synchronous advantages of recognizing, ortho-(orthoepy and orthography), querying and typing, and provides a system having man-machine combined, interaction of teaching and learning, which is reflective and interesting, and therefore it is an efficient and convenient Chinese learning method/system suitable for all ages and all nations.

### DESCRIPTION OF THE DRAWINGS

FIG. 1 is a keyboard structure of the multidimensional Chinese input method according to the present invention.

FIG. 2 is an illustration of the multidimensional Chinese learning system according to the present invention.

FIG. 3 is a pattern selection flowchart of the multidimensional Chinese learning system according to the present invention.

FIG. 4 is a PinYin study selection flowchart of the multidimensional Chinese learning system according to the present invention.

FIG. 5 is a recognizing study selection flowchart of the multidimensional Chinese learning system according to the present invention.

FIG. 6 is a dictionary inquiry selection flowchart of the multidimensional Chinese learning system according to the present invention.

FIG. 7 shows an operating interface illustration of the multidimensional Chinese learning system according to the present invention.

FIG. 8 shows a user interface illustration of the multidimensional Chinese learning system for PinYin study according to the present invention.

FIG. 8A shows an initial study interface illustration of the multidimensional Chinese learning system according to the present invention; 8B shows a single-final study interface illustration; 8C shows a multiple-final study interface illustration; 8D shows an overall recognizing and PinYin study interface illustration; 8E shows a study interface illustration in exercise unit.

FIG. 9 shows a user interface illustration of the multidimensional Chinese learning system for character recognizing study according to the present invention.

FIG. 9A shows a basic stroke study interface illustration in the multidimensional Chinese learning system according to the present invention; 9B shows a stroke order study interface illustration; 9C shows a Chinese character structure study interface illustration; 9D shows a component recognizing study interface illustration; 9E shows an encoding study interface illustration.

FIG. 10A-10F is a series of drawings illustrating the hieroglyphic evolution of component characters in the multidimensional Chinese learning system according to the present invention.

FIG. 11 shows a user interface illustration for dictionary searching in the multidimensional Chinese learning system according to the present invention.

FIG. 11A shows a dictionary study illustration in the multidimensional Chinese learning system according to the present invention; 11B illustrates how to use PinYin for searching a character and displaying the result; 11C shows the characters searched by PinYin.

### DETAILED DESCRIPTION OF THE PREFERRED EMBODIMENTS

The preferred embodiments of the multidimensional Chinese learning system enclosed with the attached drawings according to the present invention are described as following:

The First Implementation

According to the present invention, the multidimensional Chinese character encoding method comes from the following ideas:

(1) Chinese characters are divided into the following: “five basic strokes”, “basic component character”, “basic component”, “ordinary component character” and “ordinary component”, which are elements of Chinese characters, Chinese characters could be divided into one or more elements, which are collectively referred to as components;

Five basic strokes: including “ [symbol] ”, “ [symbol] ”, “ [symbol] ”, “ [symbol] ” and “ [symbol] ”, are located at “H”, “S”, “D”, “P” and “Z” key on standard computer keyboard according to their pronunciations;

Basic component character: 26 characters, including single characters, overlapped characters, un-dividable integrated characters, all of which are frequently used as radicals, are distributed at the corresponding 26 alphabetic keys according to their initial or final pronunciations or hieroglyphs, for example: “ [symbol] ” has the PinYin “quan”, with “q” as its initial, thus being defined on key Q; “ [symbol] ” has the PinYin “er”, with “e” as its final, thus defined of key E; “ [symbol] ” has the PinYin “shou”, with “o” as the first character of its final, thus defined on key O; “ [symbol] ” has the PinYin “yu”, with “u” as its final, thus defined on key U; “ [symbol] ” has the PinYin “yi”, with “I” as its finals, thus defined of key I; “ [symbol] ” is defined on key V according to its hieroglyph;

Basic component: to locate the deformation components of the basic component character at the same keys as the respective basic component characters, for example:

Ordinary component character: 245 characters, including single characters, overlapped characters, un-dividable integrated characters which are frequently used as radicals, are distributed at the corresponding 26 alphabetic keys according to their initial or final pronunciations or hieroglyphs, for example: “ [symbol] ” has the PinYin “wang”, with “w” as its initial, thus defined on key W; “ [symbol] ” has the PinYin “er”, with “e” as its final, thus defined on key E; the ones PinYin “yi”, “yu”, “ya”, “wo” and “shou” are placed at 5 alphabetic keys on computer keyboard corresponding to first PinYin alphabets of the finals; such as: “ [symbol] ” has the PinYin “wo”, with “o” as its final, thus defined on key O;

Ordinary component: component which are derived from ordinary component characters into the components that have the same pronunciations and similar shapes, or frequently used as radicals, are located at the same keys as ordinary component characters, for example: “ [symbol] ” is the deformation of “ [symbol] ”; “ [symbol] ” are in similar form of “ [symbol] ”; according to this, the resultant keyboard is combined with the existing computer;

(2) Chinese character inputting method: to divide Chinese characters into components, encode the components based on their stroke orders, and input Chinese characters by pressing corresponding keys on the keyboard.

The correspondences between said components and the keys are:
A— [symbol]
B— [symbol] [symbol] [symbol] [symbol]
C— [symbol] [symbol] [symbol] [symbol] [symbol]
D— [symbol] [symbol] [symbol]
E— [symbol] [symbol]
F— [symbol] [symbol]
G— [symbol] [symbol] [symbol]
H— [symbol] [symbol]
I— [symbol]
J— [symbol] [symbol] [symbol] [symbol] [symbol]
K— [symbol]
L— [symbol] [symbol] [symbol]
M— [symbol] [symbol] [symbol]
N— [symbol] [symbol]
O— [symbol]
P— [symbol]
Q— [symbol] [symbol] [symbol] [symbol]
R— [symbol]
S— [symbol] [symbol] [symbol] [symbol] [symbol]
T— [symbol]
U— [symbol] [symbol]
V— [symbol]
W— [symbol] [symbol] [symbol] [symbol]
X— [symbol] [symbol] [symbol]
Y— [symbol] [symbol] [symbol] [symbol]
Z—

[symbol]

[symbol]

[symbol]

[symbol]

wherein the correspondences between basic component characters and the keys are: A— [symbol] , B— [symbol] , C— [symbol] , D— [symbol] , E— [symbol] , F— [symbol] , G— [symbol] , H— [symbol] , I— [symbol] , J— [symbol] , K— [symbol] , L— [symbol] , M— [symbol] , N— [symbol] , O— [symbol] , P—

[symbol]

[symbol]

[symbol]

During the Chinese input process, the frequently used characters can be completed without inputting the entire codes. Therefore, each key contains ten first-degree brevity code, which are: A— [symbol] , B— [symbol] , C— [symbol] , D— [symbol] , E— [symbol] , F— [symbol] , G— [symbol] , H— [symbol] , I— [symbol] , J— [symbol] , K— [symbol] , L— [symbol] , M— [symbol] , N— [symbol] , O— [symbol] , P— [symbol] , Q— [symbol] , R— [symbol] , S— [symbol] , T— [symbol] , U— [symbol] , V— [symbol] , W— [symbol] , X— [symbol] , Y— [symbol] , Z— [symbol] .

The multidimensional Chinese encoding inputting method consists of:

(1) Character input, including:

One-component character: firstly, to input the alphabetic key where the component character locates, then to input the alphabetic keys where the first, second and last strokes locate, according to stroke order;

For example: [symbol] —R+S+Z+H [symbol] —B+S+Z+D

Two-component character: to input the respective alphabetic keys where the components locate and the alphabetic keys where the first strokes of the components locate:

For example: [symbol] —R+Y+S+P [symbol] —R+W+P+H

Three or four-component characters: to input the alphabetic key where each component locates;

[symbol] —S+K+W [symbol] —R+D+K+H

[symbol] —S+D+K [symbol] —C+R+D+L

More than four component characters: to input the alphabetic keys where the first, second, third, and last component keys locate;

For example: [symbol] —S+S+R+Y [symbol] —M+C+K+Z

(2) Word inputting, including:

Two-character word: to sequentially input the alphabetic keys of the first two components of the two characters; if one of them is a component character, just input the alphabetic key of the component character; if both are component characters, after inputting alphabetic keys of respective component characters, input the alphabetic key of the second component again;

For example:

[symbol] —F+J+B+D

[symbol] —T+T+Y ( [symbol] is a component character.)

[symbol] —G+R+R (Both [symbol] and [symbol] are component characters, so the encoding of [symbol] is input again.)

Three-character word: to input the alphabetic keys where the first components of the first two characters and the first two components of the third character locate; if there is a component character, only input the alphabetic key of the component character;

For example:

[symbol] —Y+Z+M+J

[symbol] —M+K+R ( [symbol] is a component character, so only input R as the code for [symbol] .)

Four-character word: to input the alphabetic key of the first components of each character; if there is a component character, only input the alphabetic key of the component character;

For example:

[symbol] —S+S+S+L

[symbol] —B+J+B+L (All of which are component characters.)

Multi-character word: to input the alphabetic keys where the first components of the first four characters locate; if there is a component character, only input the alphabetic key of the component character;

For example: [symbol] —Z+R+R+M

(3) Brevity code characters input:

Brevity code character refers to characters that are completed by only inputting one to three keys and pressing SPACE thereafter.

First-degree brevity code: to press the key where the first alphabet of the pronunciation locates, then press SPACE to enter;

For example: [symbol] —Q+SPACE [symbol] —R+SPACE

Second-degree brevity code: to press the alphabet keys where the first two components of the character locate, then press SPACE;

For example: [symbol] —RY+SPACE

Third-degree brevity code: to press the keys where the first three components of the character locate, then press SPACE;

For example: [symbol] —SYB+SPACE

The Second Implementation

The Chinese inputting method according to the present invention is compatible with corresponding inputting methods such as simplified characters, traditional characters, English words and PinYins.

(1) When it is difficult to divide a character but the PinYins is known, it can be input in full-PinYin mode without switching the inputting method.

For example: [symbol] —DAI

(2) When it is convenient to input a word by inputting English, it can be done by inputting corresponding English to get the Chinese word.

For example: [symbol] —OFFICE

(3) Traditional characters can be input by inputting the component codes based on their structures.

For example: [symbol] —SFDZ

The Third Implementation

According to the overall design of the 1^{st} Implementation and the component locations on the keyboard layout, the conventional principle that overlapped characters cannot be detached has been changed, and also, Chinese characters can be divided into component or stroke codes based on the stroke orders.

For example:

[symbol] + [symbol] + [symbol]
[symbol] —“ [symbol] ” “ [symbol] ” or “ [symbol] ” “ [symbol] ” “ [symbol] ”

The Fourth Implementation

A computer implemented system facilitates Chinese learning by means of displaying characters and playing pronunciations; said system will help learners improve all kinds of abilities in hearing, speaking, reading and writing. Therefore the present invention can take advantage of both systems and methods in order to achieve the above objectives.

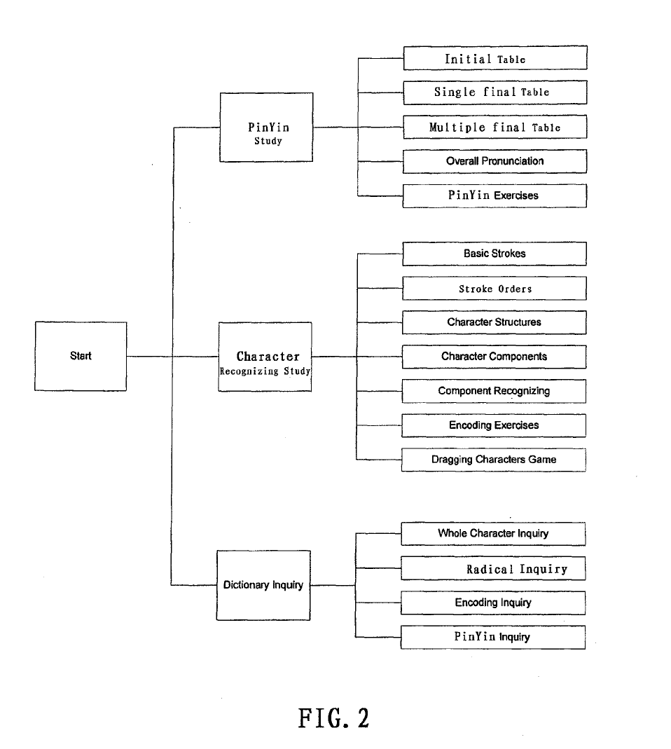

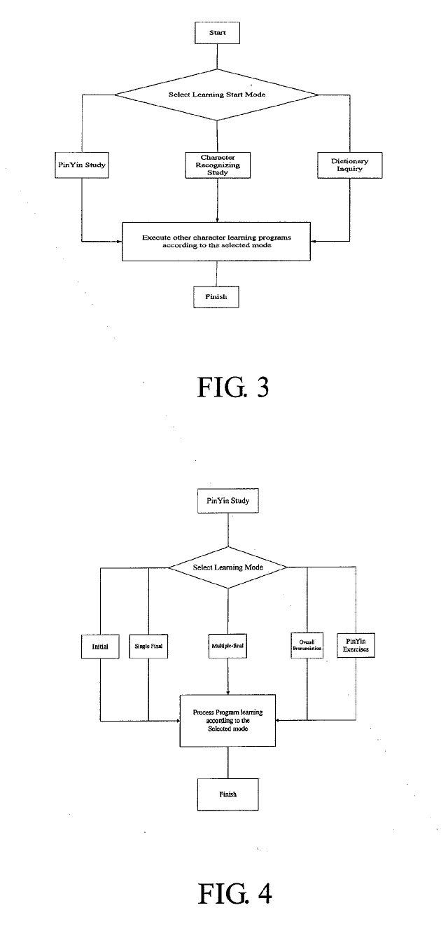

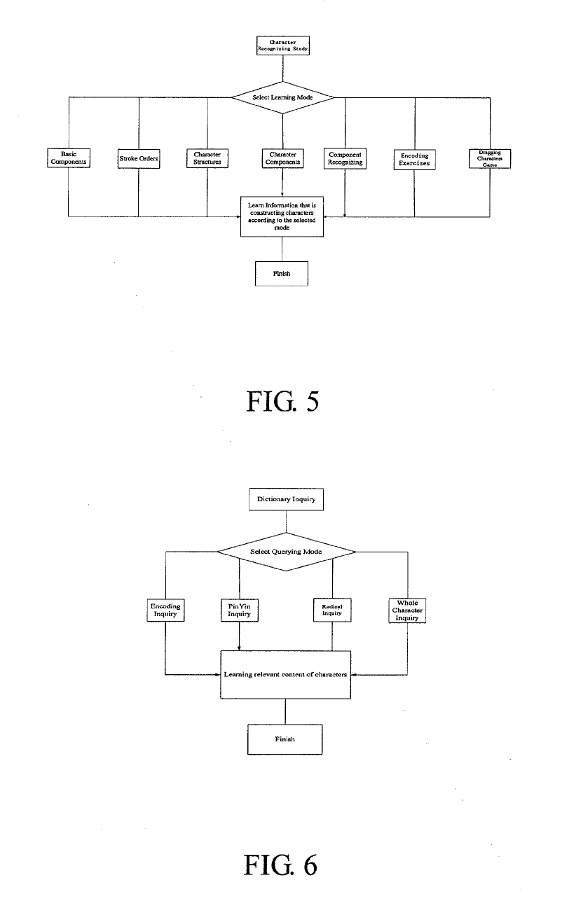

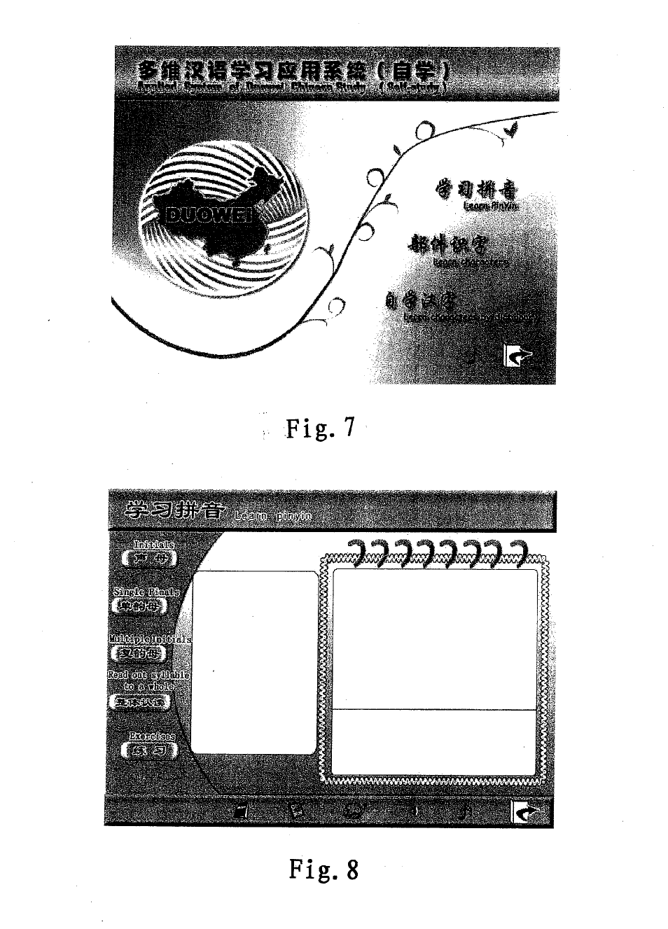

Firstly, the system structure of the present invention is illustrated in FIG. 2 and FIG. 3. Said system comprises a mainframe computer, a data storage device installed in the mainframe computer, and an inputting device. Learners can access the user interface shown in FIG. 7 on learning machines or computers, enter into the PinYin study module, recognizing study module and dictionary inquiry module, wherein the PinYin study module comprises an initial study unit, a single-final study unit, a multiple-final study unit, an overall PinYin unit and an exercise unit, as shown in FIG. 4; the recognizing module comprises a stroke unit, a stroke order unit, a structure unit, a component unit, an encoding unit and a game unit, as shown in FIG. 5; the component recognizing unit including recognition and PinYin of two-character word, three-character word and multi-character word, are characters with same shape components or same pronouncing components and part of the hieroglyphs in classified and concentrated study, up to a total of more than 300 characters. The components constructing these characters are also frequently used as radicals in constructing characters. This learning procedure can deepen the memory of character components and the understanding of their meanings, hence will help grasp the rules of building characters and recognizing characters. Learning content of each Chinese character comprises: PinYin, stroke order, character meaning, constructing words, word meaning, constructing sentences, components division and multidimensional encoding. Dictionary inquiry module comprises an input unit, an inquiry unit and a display unit, as shown in FIG. 6.

Said data storage unit saves all the teaching materials and other related information of the multidimensional Chinese learning method, and displays or plays them, including: pronunciation tips, stroke orders, pictures, animations, background music, key encoding, character constructing, PinYins, strokes, radicals, character building, structures, multidimensional code, static and dynamic stroke orders, division, encoding rules, pronunciations, evolution of Chinese characters, background music, word constructing, word properties, character series, word constructing and meanings.

The exercise unit in PinYin module of said learning system comprises at least one of PinYin exercises, pictures recognizing, initials and finals hit, phrase exercises and sentence exercises; the inquiry unit in dictionary inquiry modules comprises at least one of encoding inquiries, radicals inquiries, PinYin inquiries and entire character inquiries.

When the learners start to use such learning systems, the storage module shows index related to Chinese learning for learners to choose, and enters into a relevant database according to the learner's choices, as illustrated in FIG. 4, FIG. 5 and FIG. 6 below, to provide and display information related to this character. Thereafter, learners can access the user interface provided by the system and select a character or sentence or PinYins to learn Chinese characters and relevant content.

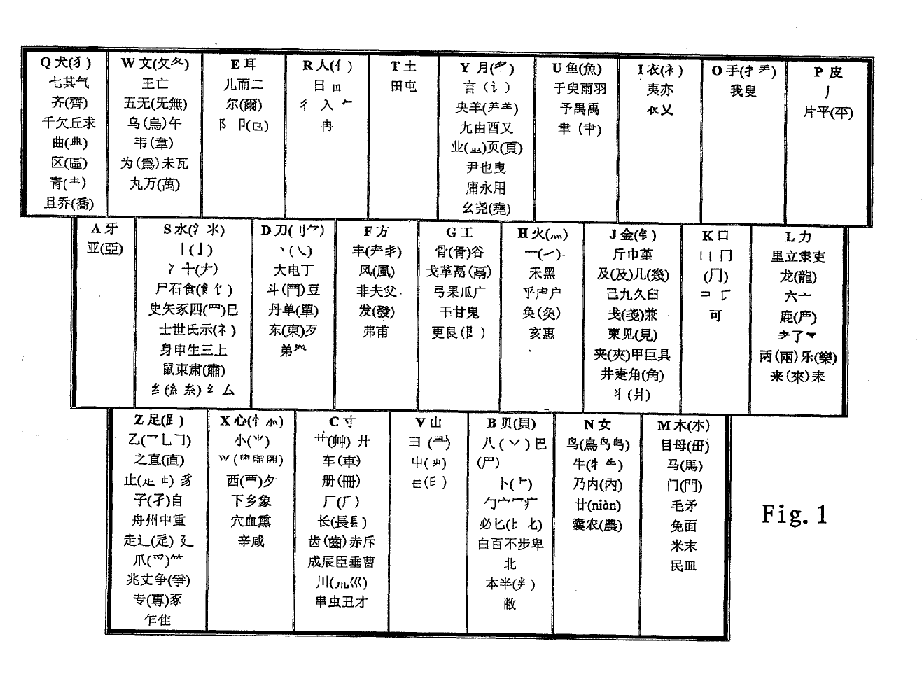

Following the description of the system structure, the system operating process of the present invention is illustrated with the flowcharts shown in FIG. 2 and FIG. 3. The processing method of the present invention is achieved by a main computer, an input unit and a data storage unit installed in the computer, said input unit being a keyboard using multidimensional Chinese encoding inputting method, as shown in FIG. 1.

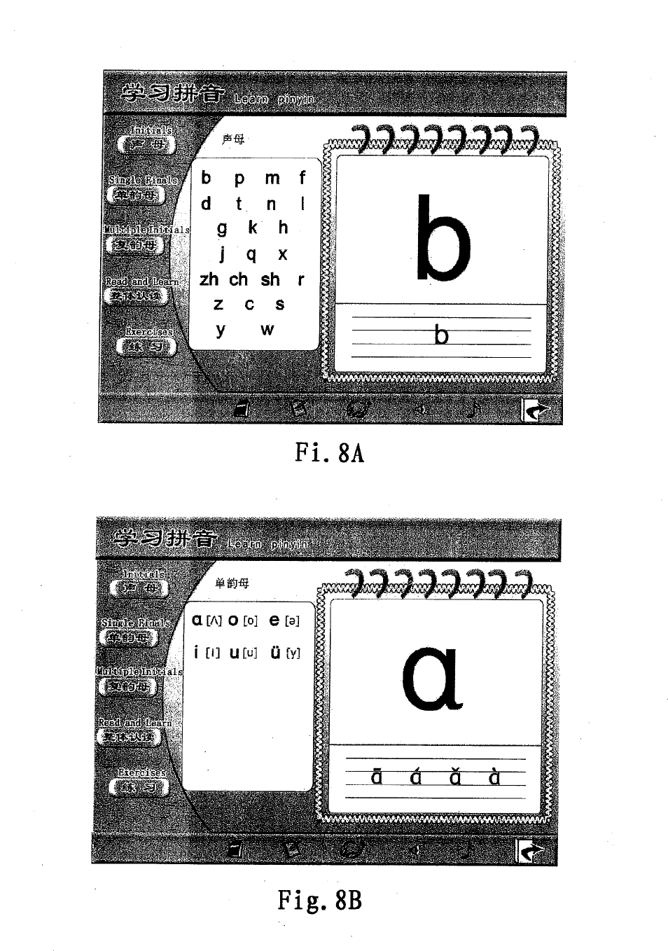

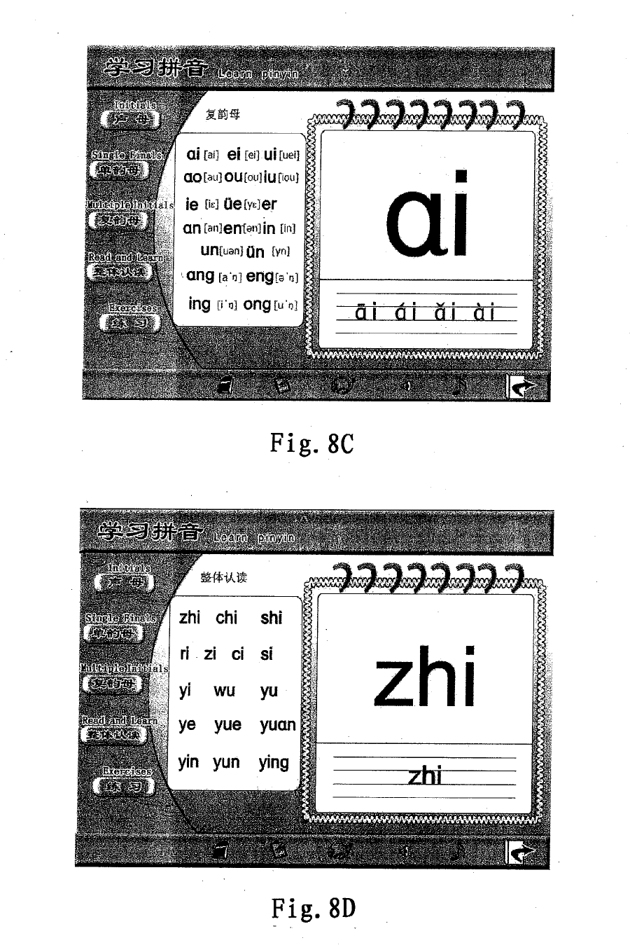

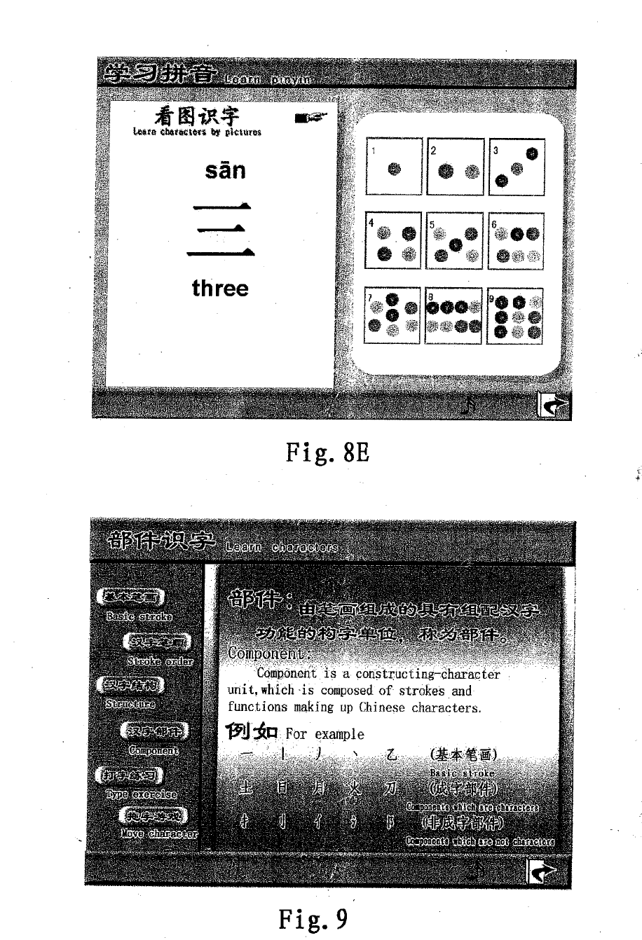

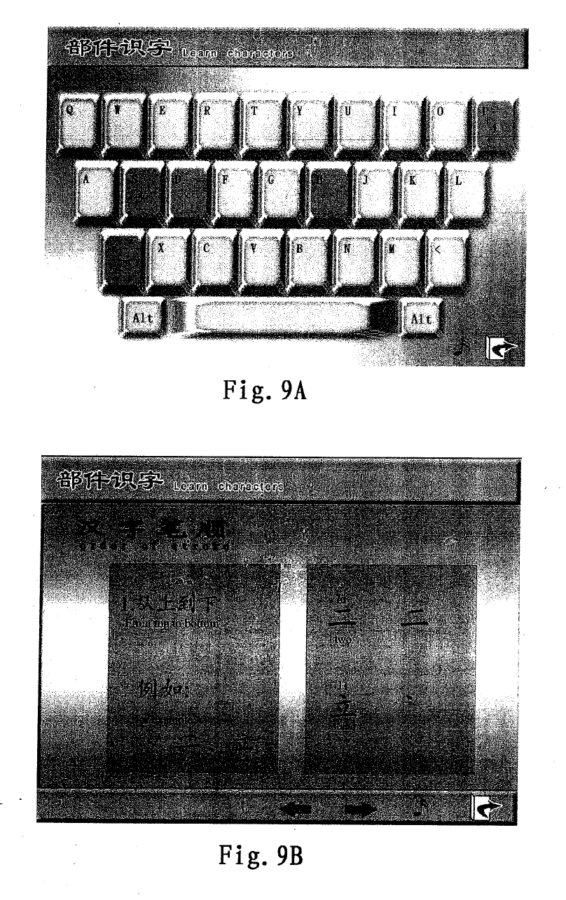

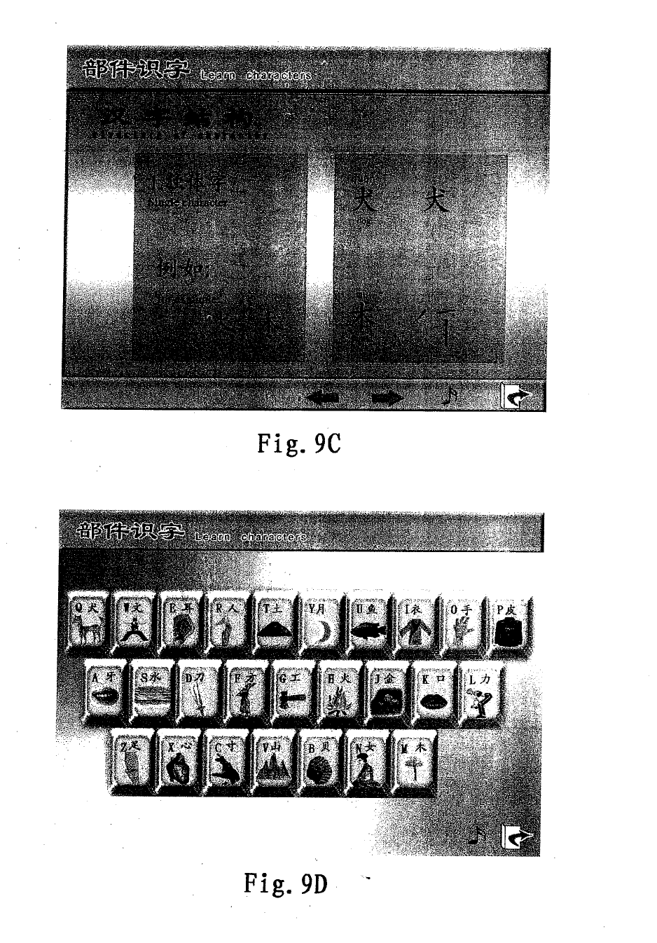

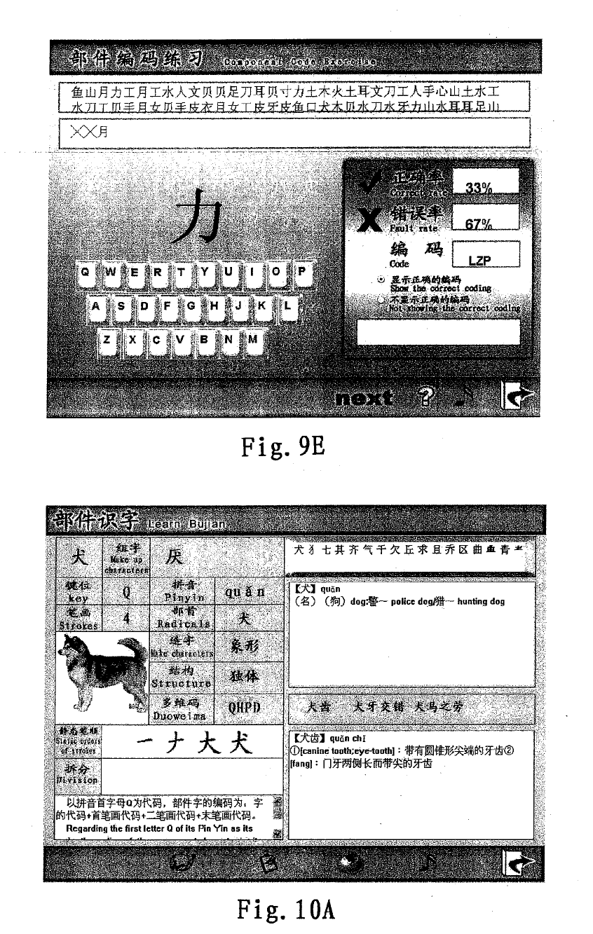

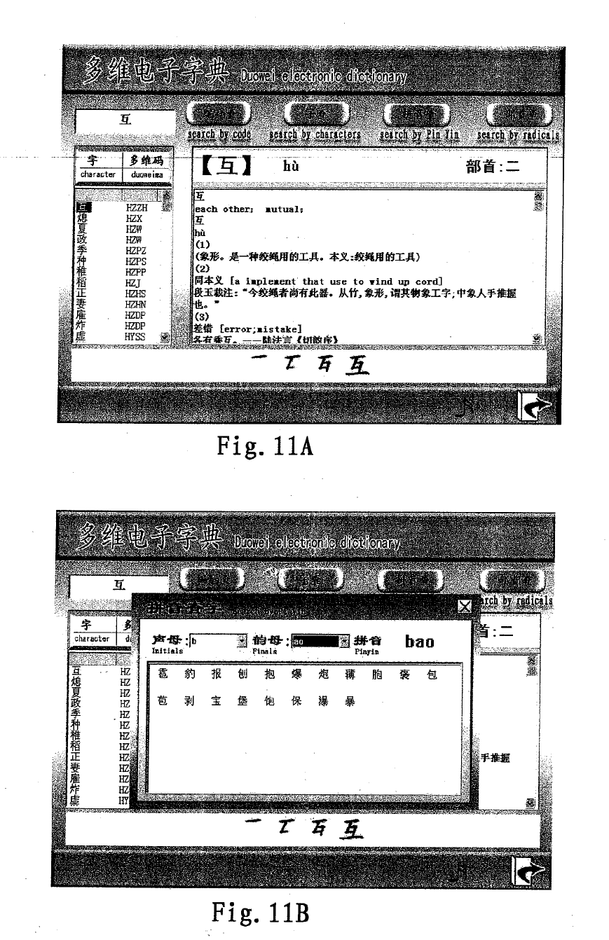

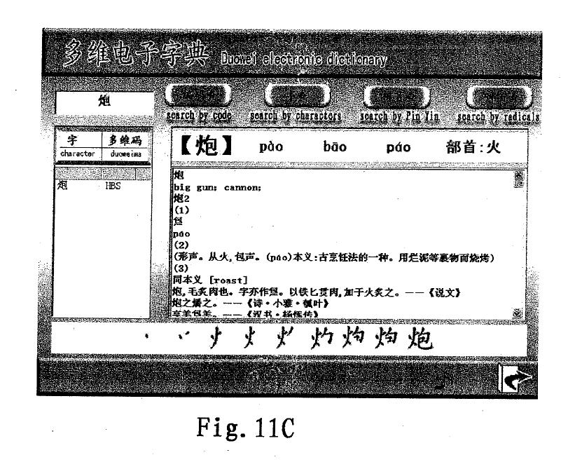

Firstly, after the study is started by the user, the system will display the Chinese learning Index (FIG. 7) for user to choose; after the selection, the system will show the selected content and display the corresponding user interface, as shown in FIG. 8, FIG. 9 and FIG. 11, and then enters into the corresponding learning program after the selection.

Now referring to an embodiment along with flowcharts 8A to 8E and FIGS. 9A to 9E, the whole process learning Chinese language is explained.

The learning mode selection flowchart of the present invention is shown in FIG. 2. When learners select PinYin study, the system will display learning modes in the PinYin module for learners to choose, and enter the user interface shown in FIG. 8; at this time, learners can select a learning mode according to the user interface provided by system, said learning mode providing an initial study (FIG. 8A), a single-final study (FIG. 8B), a multiple-final study (FIG. 8C), an overall PinYin (FIG. 8D) and a PinYin exercises (FIG. 8E); each step of the study includes PinYin and alphabetic pronunciation tips, writing, reading, four-tone functions and background music buttons.

Said PinYin exercise unit includes:

PinYin exercise, which is an arbitrary combining exercise of initials and finals;

Recognizing characters by picture, which is a Chinese character PinYin with reference to graphical objects;

Initial and final hitting, which include clicking START button with a mouse, displaying audio and video of Chinese character, searching for the final adapted to the initial, and playing audio tips;

Phrase and sentence exercises, which include displaying Chinese characters and PinYins, English interpretation and pronunciation thereof.

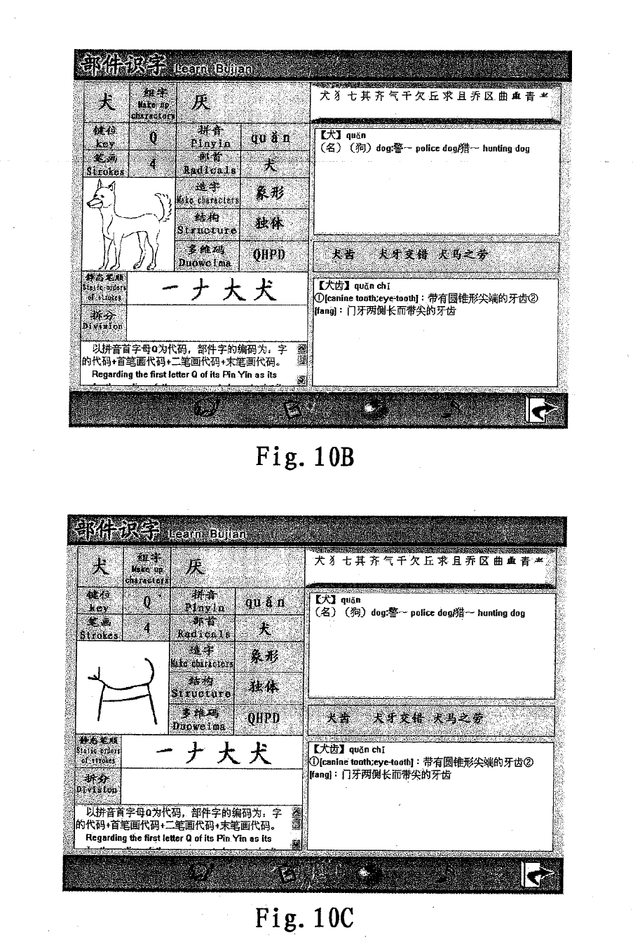

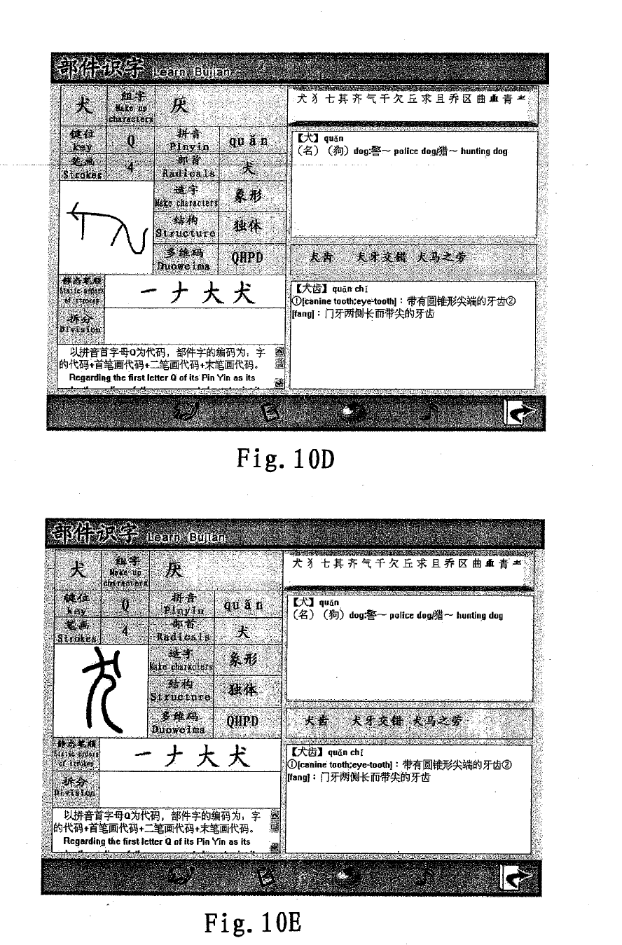

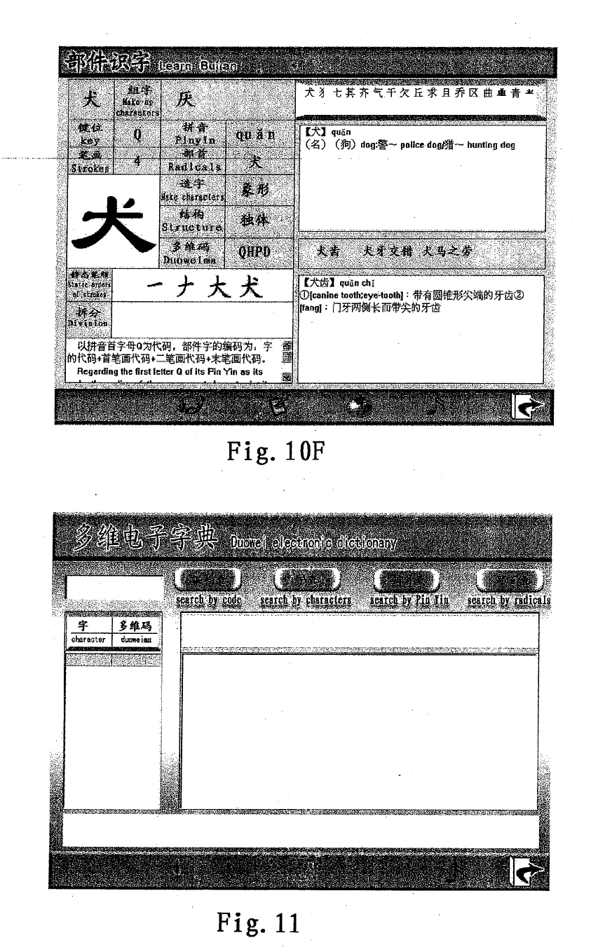

After learning Chinese PinYins, Chinese characters can be further studied, as shown in FIG. 9A to 9E. When learners access the recognizing study through the selection mode in FIG. 3, the user interface shown in FIG. 9 is displayed. At this time learners can choose from learning modes according to the user interface provided by the system, said learning mode provides five basic strokes (FIG. 9A), stroke orders (FIG. 9B), structures (FIG. 9C), components and overall character study (FIG. 9D), and encoding exercises (FIG. 9E) of Chinese characters, wherein the five basic strokes comprising “ [symbol] ”, “ [symbol] ”, “ [symbol] ”, “ [symbol] ”, “ [symbol] ”. The Chinese characters stroke order comprises: from top to bottom, such as “ [symbol] ”; from left to right, such as “ [symbol] ”; first horizontal then vertical, such as “ [symbol] ”; first [symbol] then [symbol] , such as “ [symbol] ”; upper and upper right encircled strokes at first, such as “ [symbol] ”; “ [symbol] ”; lower and lower left encircled strokes at last, such as “ [symbol] ” “ [symbol] ”; internal first and then encircle, such as “ [symbol] ”; center first and then two sides, such as “ [symbol] ”; dot first if the dot is at the left position, such as “ [symbol] ”; dot last if the dot is at the middle position, such as “ [symbol] ”; dot last if the dot is at the left position, such as “ [symbol] ”. The Chinese character structure comprises single characters, upper and lower structure, upper middle and lower structure, left and right structure, left middle and right structure, half encircled structure, full encircled structure and “ [symbol] ” structure. When learners select the component recognizing unit, the system will show a keyboard with multidimensional computer encoding inputting method, as shown in FIG. 1; then after pressing any key for learning content related to that key encoding, the basic component characters learning is provided by system, including learning modes such as key encoding, characters formed by the components on the key, and the PinYins, strokes, radicals, character building, structures, multidimensional codes, evolution of Chinese characters (FIG. 10), division, encoding rules, pronunciations, dynamic and static stroke orders, background music, words grouping, word properties, interpretations and etc. After the basic component characters are studied, other ordinary characters formed by said components can be learned by clicking on the character, so as to enhance the level of Chinese learner.

When the learners are learning, the unknown characters and the characters that are not clear about the meanings may be looked up in the dictionary. After entering the dictionary inquiry interface shown in FIG. 11, learners can look up the character in terms of the PinYins, radicals, encodings and overall character inquiry based on their understanding of the character. When an inquiry mode is entered into the input unit, the display unit will show the character series, multidimensional code, character, words of the character and the meaning of the character and words in relation to the input information, as shown in FIG. 11A. When PinYin inquiries are selected, the system will display the initial list and the final list, and show all the characters that have the pronunciation formed by the selected initial and final, as shown in FIG. 11B, each character can be learned after being clicked. When overall character inquiries are selected, the system will display all the information about this character, as shown in FIG. 11C.

1. A multidimensional Chinese learning system including a main computer, a data storage device installed in the main computer, and an input device, characterized in that said data storage device comprises:
a PinYin module, including an initial learning unit, a single-final learning unit, a multiple-final learning unit, an overall reading unit and an exercise unit;
a recognizing module, including a stroke unit, a stroke order unit, a structure unit, a component unit, a component recognizing unit, an encoding unit and a game unit;
a dictionary querying module, including an encoding unit, a querying unit and a display unit.

2. The multidimensional Chinese learning system according to claim 1, characterized by the exercise unit of the PinYin module comprises at least one of PinYin exercise means, picture based character recognizing means, initials and finals hitting means, phrase exercises and sentence exercise means.

3. The multidimensional Chinese learning application system according to claim 1 or 2, characterized by any unit of the PinYin module and recognizing module comprises at least one of PinYin tips, stroke order, sounds, pictures, animations, background music and display unit.

4. The multidimensional Chinese learning application system according to claim 1 or 2, characterized by the component unit comprises at least one of component encoding, character constructing, PinYins, strokes, radicals, character building, structures, word code, static stroke order, division, encoding rules, pronunciations, dynamic stroke order, evolution of Chinese characters, background music, word constructing, word properties and interpretations.

5. The multidimensional Chinese learning application system according to claim 1 or 2, characterized by the querying unit comprises at least one of encoding searching, radicals searching, PinYin searching and overall character searching.

6. The multidimensional Chinese learning application system according to claim 1, characterized by the display unit of the dictionary inquiry module comprises at least one of character sequence, word constructing, radicals, stroke orders and interpretations.

7. A multidimensional Chinese learning method, said method uses a main computer, an input unit and a data storage unit installed in the mainframe computer, characterized by the following steps:
PinYin studying step, which learns the initials, finals, overall pronunciations, syllabic pronunciations, and four tones of Chinese characters, including a initial study, a single-final study, a multiple-final study, an overall pronunciations and PinYin exercises.
character recognizing step, which learns the five basic strokes of Chinese characters, stroke orders and structures, so as to learn components and the overall character, encoding exercises;
dictionary searching step, which uses component encoding to search an electronic dictionary, learn pronunciations and meanings of Chinese characters, Chinese and English interpretation of words, wherein the encoding, radicals, entire character and PinYin are input into the input unit;
each of the above steps includes a displaying step.

8. The multidimensional Chinese learning method according to claim 7, characterized by any of the PinYin studying step and character recognizing step comprises at least one of pronunciation tips, stroke orders, sounds, pictures, animation evolution and background music.

9. The multidimensional Chinese learning method according to claim 7, characterized by said PinYin exercising step comprises:
PinYin and reading exercising step, which is an arbitrary combination of initials and finals;
picture-based character recognizing step, which recognizes and reads Chinese characters with reference to graphical objects;
initial and final hitting step, which includes clicking START button with a mouse, displaying audio and video of Chinese character, searching for the final adapted to the initial, and playing audio tips;
phrase and sentence exercising step, which includes displaying Chinese characters with PinYins, English interpretation and pronunciation.

10. The multidimensional Chinese learning approach according to either of claims 7, 8 and 9, characterized by the character recognizing step consists at least one of key encoding, character constructing, PinYins, strokes, radicals, character building, structures, multidimensional codes, static stroke orders, division, encoding rules, pronunciations, rules of stroke orders, evolution of Chinese characters, background music, word constructing, word properties and meanings.
